(19) United States
(12) Patent Application Publication
(10) Pub. No.: US 2026/0055619 A1
(43) Pub. Date: Feb. 26, 2026

(54) WATERPROOF ADHESIVE COMPOSITIONS AND FLOORING SYSTEMS

(71) Applicant: Carroll Benford Dickens, Santa Ana, CA (US)

(72) Inventor: Carroll Benford Dickens, Santa Ana, CA (US)

(21) Appl. No.: 19/304,376

(22) Filed: Aug. 19, 2025

Related U.S. Application Data
(60) Provisional application No. 63/685,055, filed on Aug. 20, 2024.

(51) Int. Cl. E04F 15/02; C09J 11/06; C09J 175/04

(52) U.S. Cl. CPC E04F 15/02155; C09J 11/06; C09J 175/04; E04F 15/02038; E04F 2201/0138; E04F 2201/0153; E04F 2201/023; E04F 2201/043

(57) ABSTRACT

Adhesives and flooring material that provides a waterproof flooring system. The adhesive composition allows for dry setting by remaining sticky for at least 3 hrs before hardening. The adhesive composition can bond to non-porous substrates. The flooring material includes interlocking planks that have a V-shaped or wider groove on the bottom surface to allow for the adhesive composition to flow into a fluid channel between the interlocking planks.

### CROSS-REFERENCE TO RELATED APPLICATIONS

This application is a non-provisional and claims benefit of U.S. Provisional Application No. 63/685,055 filed Aug. 20, 2024, the specification(s) of which is/are incorporated herein in their entirety by reference.

### FIELD OF THE INVENTION

The present invention relates to flooring systems, in particular, to interlocking flooring material and waterproof adhesives.

### BACKGROUND OF THE INVENTION

Interlocking flooring planks, such as click-lock, are used in the industry for quick and easy installation of flooring material over a subfloor. The resulting floor structure may be a floating floor. One of the drawbacks of a floating floor is that, due to the fact that a physical connection to the subfloor does not exist, topical liquid penetrations at the material seam can quickly wick under the flooring. For example, a floating floor that is not physically connected to a concrete subfloor may be vulnerable to moisture wicking under the flooring material due to liquid seeping through the tile seams.

In some aspects, an adhesive may be used to secure the flooring material to the concrete or wood substrate. However, existing adhesives require the subfloor to have a porous surface. Thus, if the subfloor has a polished, sealed or coated surface, such as an epoxy topcoat, the epoxy would need to be removed to achieve necessary porosity before spreading adhesive and installing the flooring material.

Another disadvantage of existing adhesives having water-born chemistry, is their inherent sensitivity to elevated pH/moisture emissions (moisture vapor emission rate, MVER). These adhesives often require expensive topical moisture barriers to be installed for protection adding extraordinary costs in both time and money. Hence, there is a need for a new adhesive and flooring material that can provide for easier installation and adjustment as needed.

### BRIEF SUMMARY OF THE INVENTION

It is an objective of the present invention to provide systems, compositions and methods that provide waterproof adhesives, as specified in the independent claims. Embodiments of the invention are given in the dependent claims. Embodiments of the present invention can be freely combined with each other if they are not mutually exclusive.

According to some embodiments, the present invention features an adhesive composition comprising a silane modified polymer, a reinforcing extender, one or more thixotropic agents, and an adhesion promoter. Without wishing to limit the present invention, a cured product of the adhesive composition is waterproof, hydrolytically stable, and pH-resistant. When applied to a surface, the adhesive composition is sticky for about 3-4 hours before hardening.

In some embodiments, the silane modified polymer comprises a silane modified polyurethane, a silane modified polyether, a silane modified polyol, a silane modified polyester, a silane polycarboxylate, or a combination thereof. In some embodiments, an NCO content of the silane modified polyurethane is about 0.001% to about 30%. In other embodiments, the silane end-capped urethane comprises a flexible binder urethane, a slow-cure urethane, or both. In some other embodiments, the silane modified polyurethane is an aliphatic urethane, an aromatic urethane, or a combination thereof.

In some embodiments, the reinforcing extender is hydrophobically modified. In other embodiments, the one or more thixotropic agents are hydrophobically modified.

In some embodiments, the adhesion promoter enables bonding of the cured product to a non-porous substrate. Non-limiting examples of the adhesion promoter include, but are not limited to, dimorpholinediethylamine, dimorpholinodiethylether, methylmorpholine, ethylmorpholine, 4-butylmorpholine, 4-(2-aminopropyl) morpholine, 4-(2-methoxyethyl) morpholine, 4-[2-(dimethylamino)ethyl]morpholine, 4-[2-(dimethyl-amino) ethyl]morpholine, or N,N-dibenzylidenpolyoxypropylenediamine.

In some embodiments, the composition may further comprise an anti-skinning agent. The anti-skinning agent may be a methylethylketoximino (MEKO) silane according to the formula:

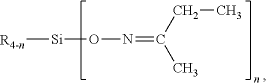

wherein n ranges from 1 to 4, wherein R is an alkyl, an alkene, or aryl group. In some other embodiments, the composition may further comprise a quenching agent, a tackifier, one or more moisture scavengers, a magnetic agent, a pigment, or a combination thereof.

According to other embodiments, the present invention features a method of installing flooring material. The method may comprise applying a layer of the adhesive composition onto a surface and applying the flooring material onto the adhesive layer. Without wishing to limit the present invention, the adhesive composition can remain sticky for about 3-4 hours after being applied. Furthermore, the adhesive composition can adhere to non-porous surfaces. For example, the surface may be polished concrete or concrete with epoxy sealer. The adhesive composition can also adhere to epoxy and glass surfaces without having to first modify the surfaces.

In some other embodiments, the present invention provides a flooring plank comprising a first locking component disposed on a bottom surface along one side of the plank, comprising a tongue adjacent to a lock channel having a tapered edge from the bottom surface, and a second locking component disposed on a top surface along an opposing side of the plank, comprising a lock key adjacent to a groove, the lock key having a tapered edge from the bottom surface. The tongue and groove can have complementary shapes such that they can interlock with the groove and tongue of adjacent floor planks. The lock channel and lock key have complementary shapes such that they can interlock with the lock key and lock channel of the adjacent floor planks. In some aspects, interlocking the first and second locking components with the second and first locking components of adjacent planks creates a fluid channel having a first end at the bottom surface and a second end at the top surface. The tapered edges of the lock channel and lock key create a V-shaped groove at the first end of the fluid channel, the V-shaped groove is configured to funnel an adhesive into the fluid channel.

One of the unique and inventive technical features of the present invention is the novel adhesive composition. Without wishing to limit the invention to any theory or mechanism, the adhesive advantageously adheres to non-porous (low-energy) substrates, which includes glass. For example, it is standard practice, when applying flooring material on top of polished concrete, or concrete with epoxy sealer; the polish or sealer must be removed beforehand to create porosity as described per ASTM F-710. This process is costly and time consuming. With the present invention, the adhesive can be added directly onto the concrete slab with the polish or sealer and will adhere to it. The flooring material can be then applied onto the adhesive layer. This significantly reduces the time to install the flooring material.

Another advantage of the present moisture-cure adhesive is that it can be used in a “Dry-Set” method. Often, flooring installation using moisture-cure chemistry requires setting into wet adhesive (Wet-Set), where the flooring material is installed while the adhesive is still wet in order to develop bond. This is because previous moisture-cure adhesives will start to cure and harden after 60 minutes. With the present invention, the adhesive cure has been delayed and does not start to transition hard until after 3-4 hours. Secondly, 30 minutes after application, the adhesive develops extraordinary tack. This significant increase in adhesive working time and tack allows for more efficient installation. The high tack nature additionally allows for a Dry-Set installation method without eliminating the possible Wet-Set option. This gives the present invention a “bi-functional” installation method. As an example, the adhesive can be applied to larger areas of the subfloor, before applying the flooring material into the adhesive. The flooring material can also be placed then removed, repositioned or adjusted as needed, and the adhesive will still stick to the flooring material. If workers are interrupted after applying the adhesive, but before applying the flooring material, they will not have to worry about the adhesive losing tack for the 3-4 hour working time. None of the presently known prior references have the unique inventive technical feature of the present invention.

In other embodiments, the present invention features a flooring plank comprising a first locking component disposed on a bottom surface along the sides and ends of the plank, and a second locking component disposed on a top surface along the sides and ends. Interlocking of the floor planks creates a V-shaped groove that is fluidly coupled to an adhesive channel within the lock. In some embodiments, the floor plank interlocking configuration is another unique and inventive technical feature of the present invention.

When connected, the floor planks form V-shaped grooves on their bottom surface that connect to fluid channels in the lock. Without wishing to limit the invention to any theory or mechanism, the V-shaped feature allows for adhesive to flow into the fluid channel. When the adhesive hardens, the flooring material forms a unitary monolithic floor. None of the presently known prior references have this unique inventive technical feature of the present invention.

Any feature or combination of features described herein are included within the scope of the present invention provided that the features included in any such combination are not mutually inconsistent as will be apparent from the context, this specification, and the knowledge of one having ordinary skill in the art. Additional advantages and aspects of the present invention are apparent in the following detailed description and claims.

### BRIEF DESCRIPTION OF THE SEVERAL VIEWS OF THE DRAWING(S)

FIG. 1A shows a non-limiting example of a flooring system of the present invention, comprising a flooring material and waterproof adhesive. The flooring material has an inter-locking configuration with a levered locking mechanism.

FIG. 1B shows another non-limiting embodiment of the flooring material of the present invention, having an alternative inter-locking configuration with a vertical locking mechanism, which is more vertical than the levered locking mechanism.

FIG. 1C show non-limiting embodiments of the flooring material.

FIG. 1D show non-limiting embodiments of the flooring material and waterproof adhesive.

FIG. 2A-2D shows another non-limiting example of a flooring material adhered to a glass substrate.

FIG. 3 shows the product specifications for a flooring material embodiment of the present invention.

FIG. 4 shows the Leed Scorecard for a flooring material embodiment of the present invention.

FIG. 5 shows the Well Scorecard for a flooring material embodiment of the present invention.

### DETAILED DESCRIPTION OF THE INVENTION

Following is a list of elements corresponding to a particular element referred to herein:
100 flooring system
110 floor surface
120 adhesive
130 flooring plank
132 bottom surface
134 side
136 top surface
138 opposing side
140 first locking component
141 tongue
142 lock channel
143 tapered edge
150 second locking component
151 groove
152 lock key
153 tapered edge
160 fluid channel
162 first end
164 second end
165 V-shaped groove

Referring now to the figures, in some embodiments, the present invention features a floor system that is completely waterproof, even from standing water, bonds to the point of destruction, and includes an adhesive that can bond to a non-porous (low-energy) substrate, which includes glass. The adhesive of the present invention includes a new adhesion promoter that enables bonding to non-porous substrate in a Dry-Set manner and a flooring material that has a wide channel on the bottom to allow flow of the adhesive into the lock mechanism.

According to some embodiments, the present invention features a flooring system (100) comprising a flooring adhesive (120), and a plurality of flooring planks (130).

In some embodiments, each flooring plank (130) may comprise a first locking component (140) disposed on a bottom surface (132) along one side (134) of the plank, and a second locking component (150) disposed on a top surface (136) along an opposing side (138) of the plank. In some embodiments, the first locking component comprises a tongue (141) adjacent to a lock channel (142), where the lock channel (142) has a tapered edge (143) from the bottom surface (132). In some embodiments, the second locking component (150) comprises a lock key (152) adjacent to a groove (151), where the lock key (152) has a tapered edge (153) from the bottom surface.

In some embodiments, the tongue (141) and groove (151) have complementary shapes such that they can interlock with the groove (151) and tongue (141) of adjacent floor planks. In some embodiments, the lock channel (142) and lock key (152) have complementary shapes such that they can interlock with the lock key (152) and lock channel (142) of the adjacent floor planks.

In some embodiments, the interlocking of the first and second locking components with the second and first locking components of adjacent planks creates a fluid channel (160) having a first end (162) at the bottom surface and a second end (164) at the top surface. The tapered edges of the lock channel and lock key create a V-shaped groove (165) at the first end of the fluid channel. The V-shaped groove (165) is configured to funnel the adhesive (120) into the fluid channel (160).

In some embodiments, the flooring adhesive (120) is configured to be applied onto a floor surface (110). The plurality of floor planks (130) are configured to be applied on top of the flooring adhesive and interlock with each other. Without wishing to limit the present invention to a particular theory or mechanism, the V-shaped grooves (165) created by the interlocking floor planks funnel the flooring adhesive (120) into the fluid channels (160).

In some embodiments, the flooring adhesive (120) and the interlocking floor planks (130) create a monolithic flooring structure with the floor surface. In some embodiments, when applied to the floor surface (110), the flooring adhesive (120) maintains stickiness for about 3-4 hours before hardening. In some embodiments, the floor surface (110) is polished concrete or concrete with epoxy sealer. In other embodiments, the floor surface (110) is an epoxy and glass surface. The adhesive composition is configured to adhere to the floor surface (110) without further modification of the floor surface (110).

According to some embodiments, the flooring adhesive (120), or adhesive composition, may comprise a silane modified polymer, a reinforcing extender, one or more thixotropic agents, and an adhesion promoter. Without wishing to limit the present invention, a cured product of the adhesive composition is waterproof, hydrolytically stable, and pH-resistant.

In some embodiments, the silane modified polymer comprises a silane modified polyurethane, a silane modified polyether, a silane modified polyol, a silane modified polyester, a silane polycarboxylate, or a combination thereof.

In some embodiments, the silane modified polymer is a silane modified polyurethane having an NCO content of about 0.001% to about 30%. In other embodiments, the silane end-capped urethane comprises a flexible binder urethane, a slow-cure urethane, or both. In some other embodiments, the silane modified polyurethane is an aliphatic urethane, an aromatic urethane, or a combination thereof. In some other embodiments, a silane modified polymer composition is a silane modified polycarboxylate or silyl-terminated polyether, a silane modified aliphatic polyurethane, a silane modified aromatic urethane, or a combination thereof.

In some embodiments, the reinforcing extender is hydrophobically modified. In other embodiments, the one or more thixotropic agents are hydrophobically modified.

In some embodiments, the adhesion promoter enables bonding of the cured product to a non-porous (low-energy) substrate. The non-porous substrate can include, but is not limited to, glass, polished concrete, or epoxy-sealed concrete. In some embodiments, the adhesion promoter may be dimorpholinediethylamine, dimorpholinodiethylether, methylmorpholine, ethylmorpholine, 4-[2-(dimethyamino)-ethyl]morpholine, 4-(2-methoxyethyl) morpholine, 4-butylmorpholine, 4-(2-aminopropyl) morpholine, 4-[2-(dimethylamino)ethyl]morpholine, or N,N-dibenzylidenpolyoxy-propylenediamine.

In some embodiments, the adhesive promoter comprises an aldimine latent curing agent. Without wishing to be bound to a particular theory or mechanism, the adhesive promoter modifies the adhesive properties of the adhesive composition to enable bonding to non-porous substrates, such as glass.

In some embodiments, the adhesion promoter is N,N-dibenzylidenepolyoxy propylenediamine (polymer). This is an aldimine latent curing agent that hydrolyses on exposure to moisture, yielding a reactive amine crosslinker and benzaldehyde. It is specially designed for one-component PU systems and is suitable for use with both aromatic and aliphatic prepolymers. Without wishing to limit the present invention, this additive prevents gross development of CO₂ gas. Furthermore, this additive enhanced bonding characteristics.

Without wishing to be bound to a particular theory or mechanism, when the adhesive is applied to a surface, the adhesive composition remains sticky for about 3-4 hours before hardening.

In some embodiments, the adhesive composition may further comprise an anti-skinning agent. The anti-skinning agent is a methylethylketoximino (MEKO) silane. In other embodiments, the adhesive composition may further comprise a quenching agent, a tackifier, one or more moisture scavengers, a magnetic agent, a pigment, or a combination thereof.

In some embodiments, the adhesive composition may further comprise a catalyst Bis(2-morpholinoethyl) Ether (DMDEE). In some embodiments, the adhesive composition the catalyst is a Dibutyltin dilaurate (DBTDL), or any number of traditional amines, or a combination thereof. In other embodiments, the adhesive composition may further comprise a quenching agent, a tackifier, one or more moisture scavengers, a magnetic agent, a pigment, or a combination thereof.

According to another embodiment, the present invention features a method of installing flooring material. In some embodiments, the flooring material is tile or planks. The method may comprise applying a layer of the adhesive composition (120) onto a surface (110) and applying the flooring material (130) onto the adhesive layer (120). In some embodiments, the adhesive composition is sticky for about 3-4 hours after being applied. In some embodiments, the adhesive composition adheres to non-porous surfaces. For example, the surface may be glass, polished concrete, or concrete with epoxy sealer.

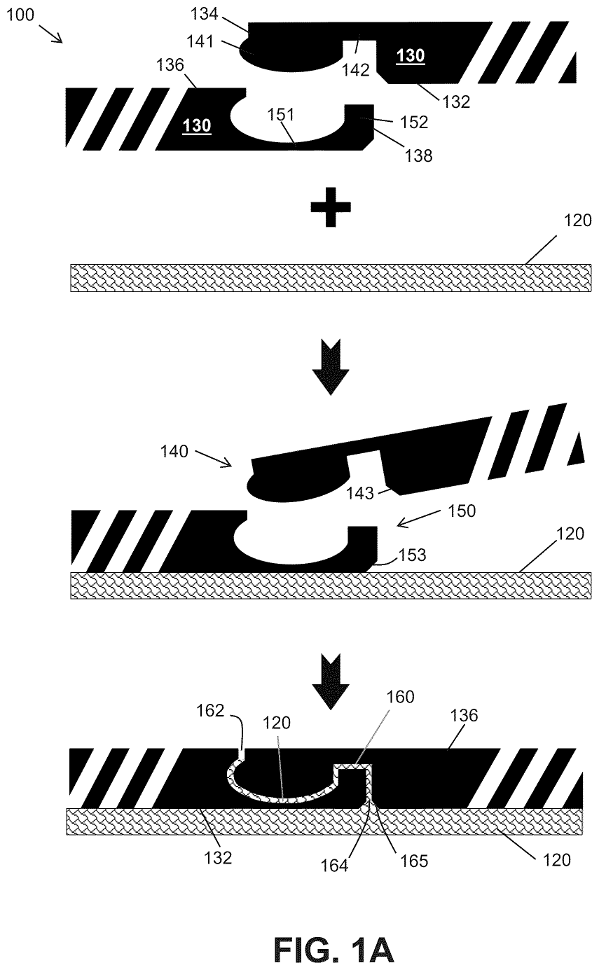

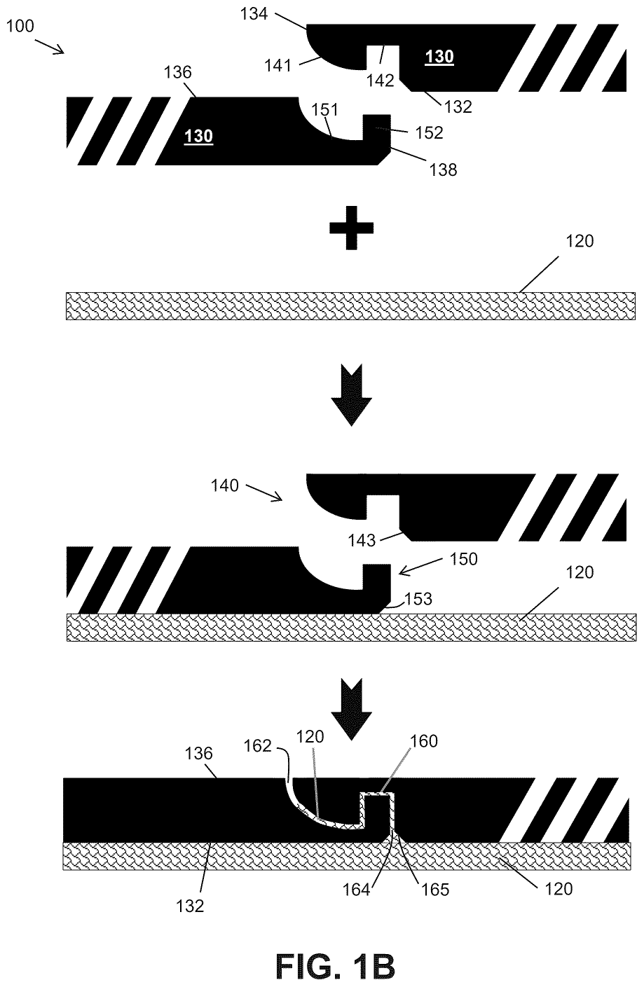

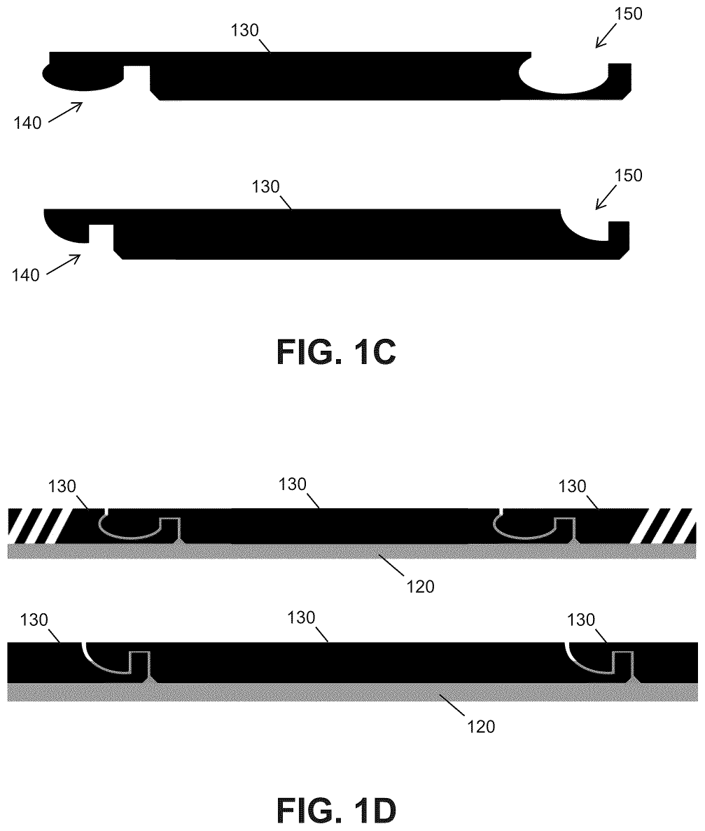

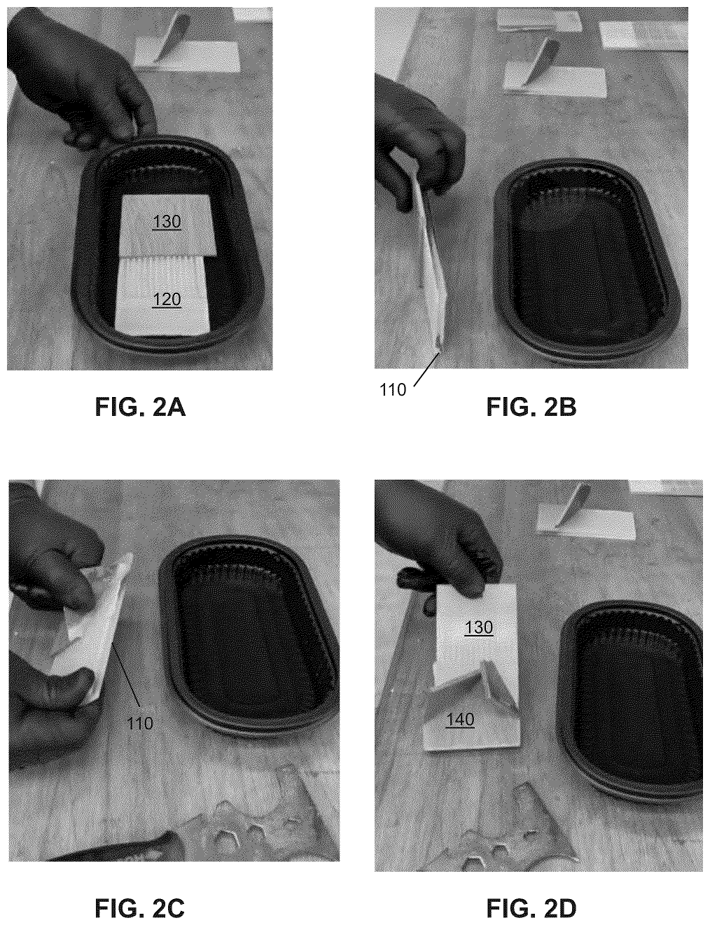

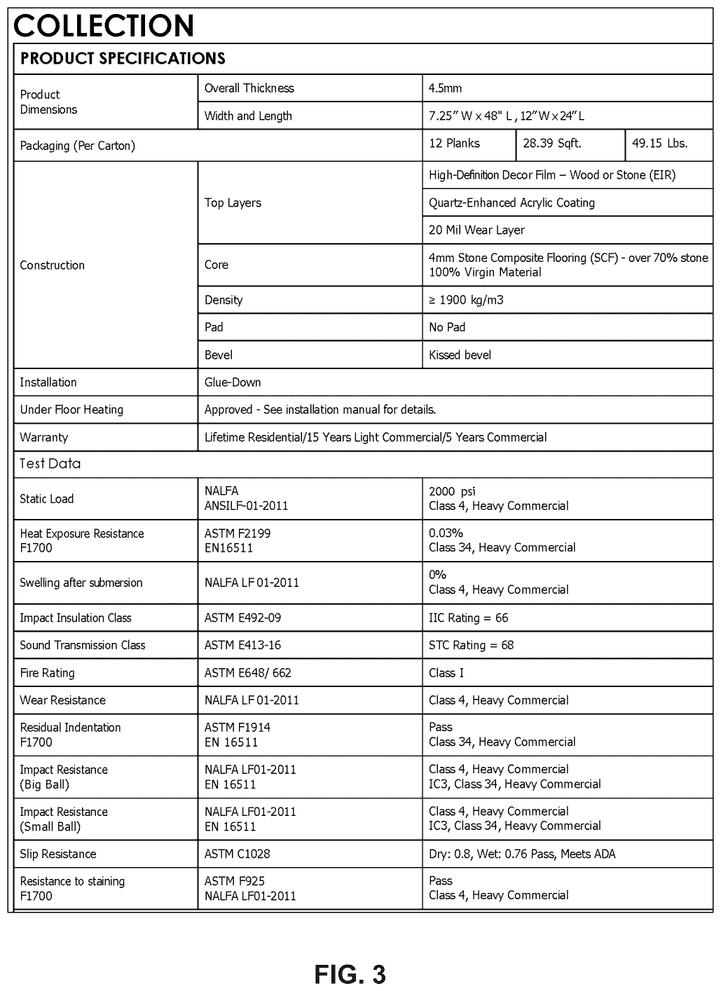

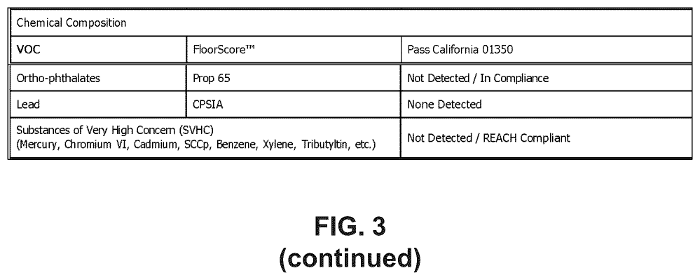

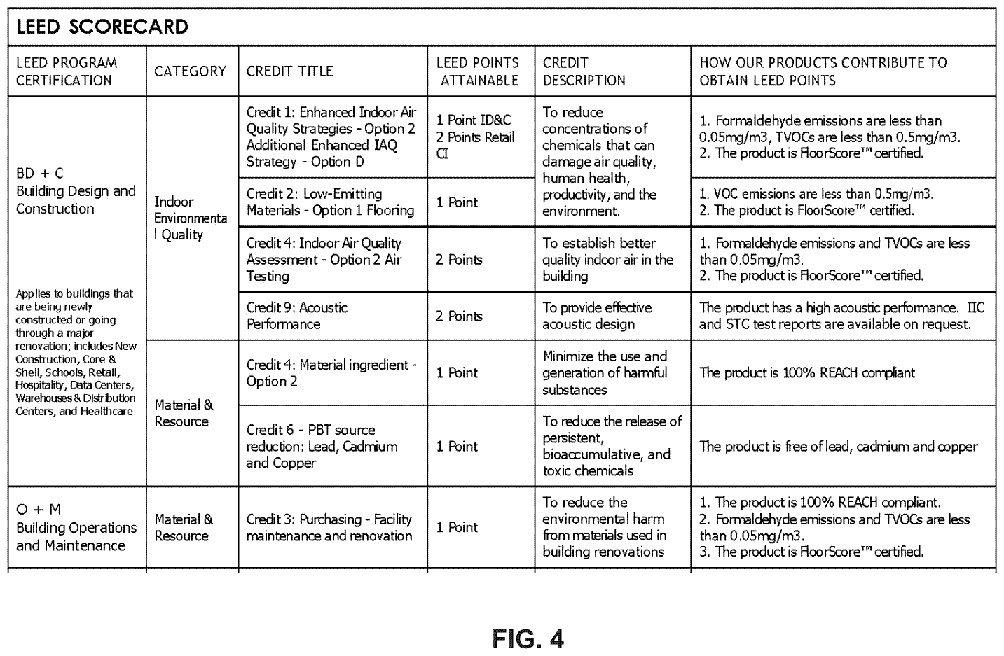

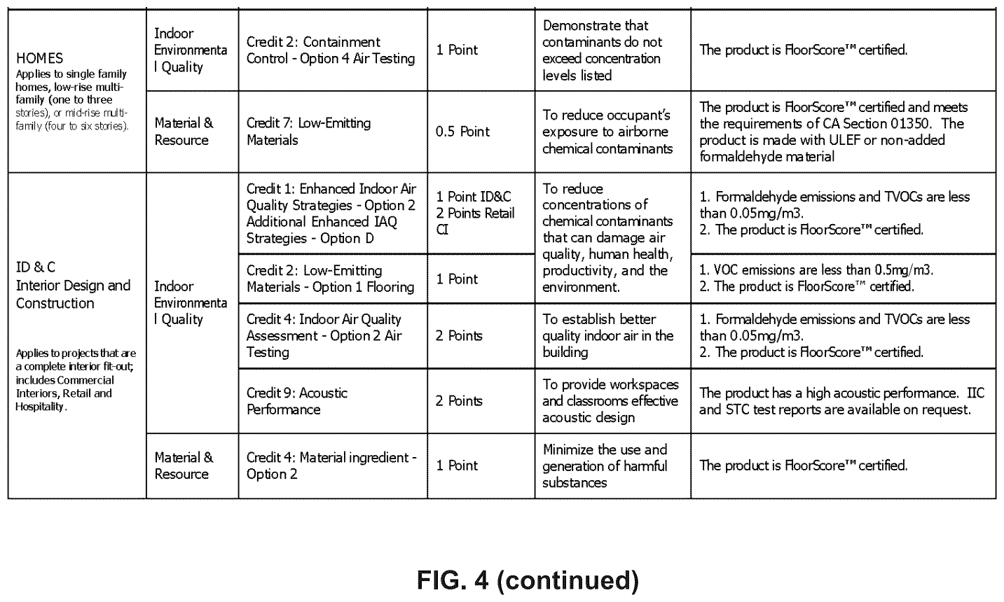

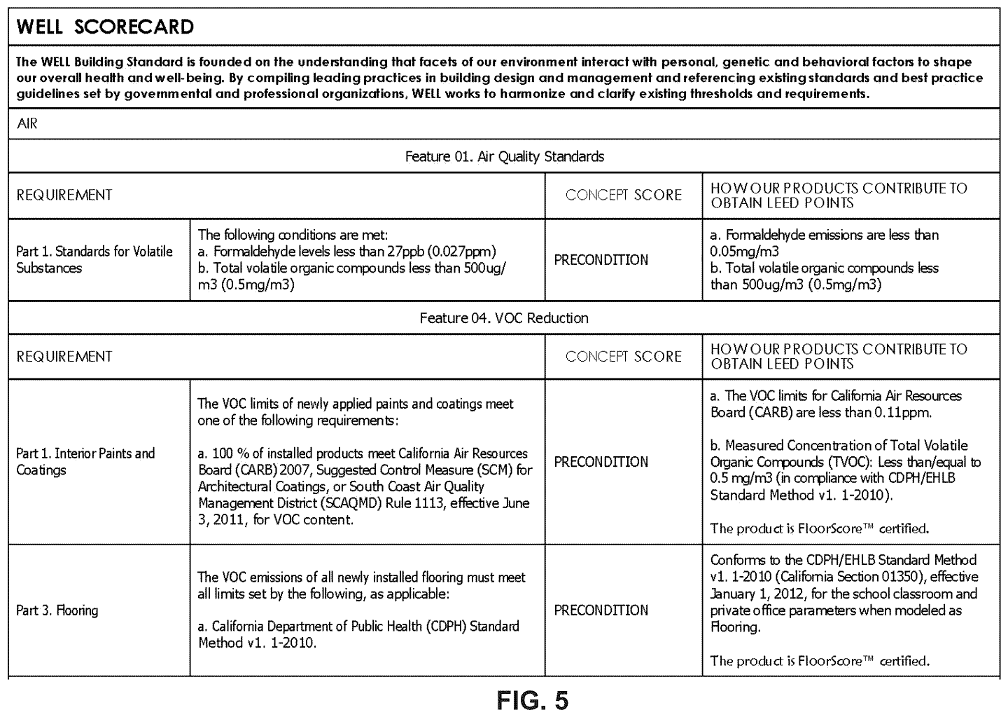

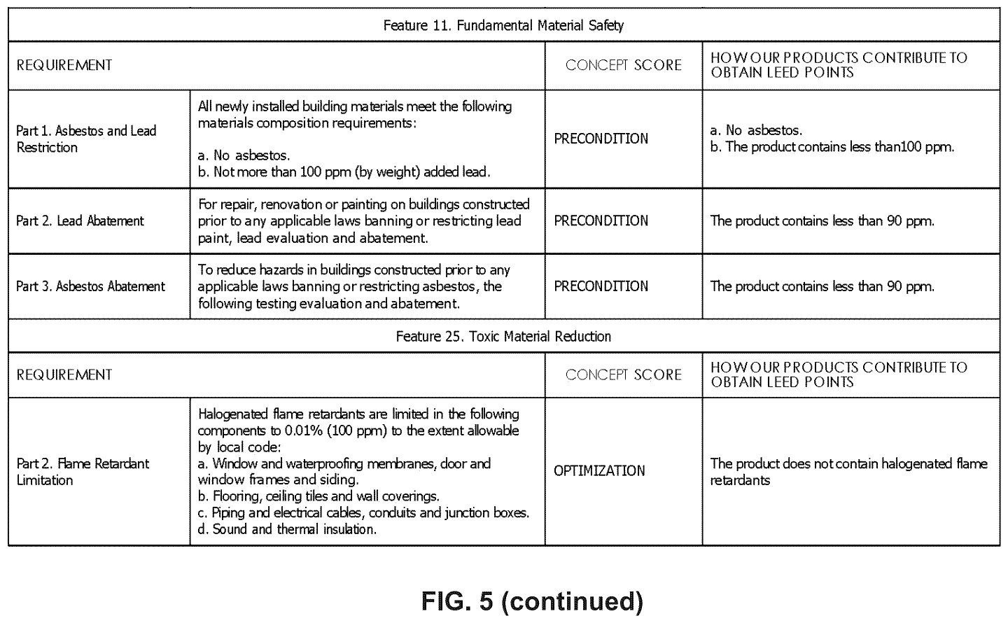

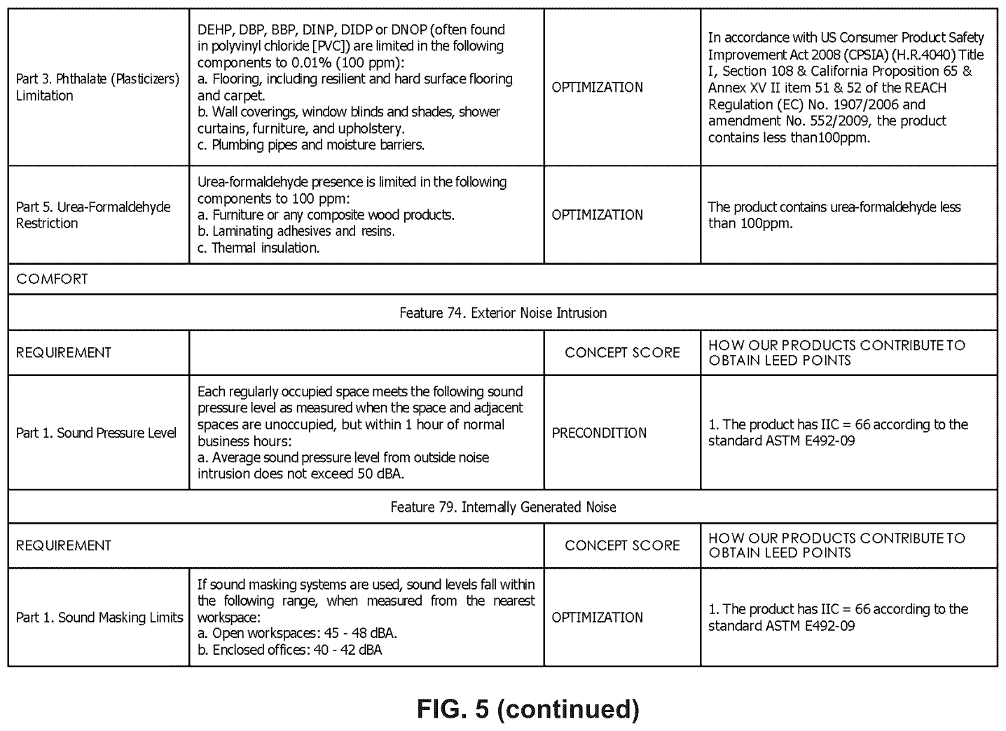

According to some embodiments, as shown in FIGS. 1A and 1B, the present invention features a flooring plank (130) comprising a first locking component (140) disposed on a bottom surface (132) along one side (134) of the plank, and a second locking component (150) disposed on a top surface (136) along an opposing side (138) of the plank. In some embodiments, the first locking component comprises a tongue (141) adjacent to a lock channel (142).

In some embodiments, the tongue (141) and groove (151) have complementary shapes such that they can interlock with the groove (151) and tongue (141) of adjacent floor planks. Referring to FIG. 1A, the tongue has a bulge or oval shape that extends past the side (134), which requires a lever-like motion to fit into the groove (151). In other embodiments, as shown in FIG. 1B, the tongue has a round shape that does not extend past the side (134), which requires press down motion to fit into the groove (151).

In some embodiments, the lock channel (142) has a tapered edge (143) that tapers from the bottom surface (132). In other embodiments, the second locking component comprises a lock key (152) adjacent to a groove (151). The lock key (152) also has a tapered edge (153) from the bottom surface. In some other embodiments, the lock channel (142) and lock key (152) have complementary shapes such that they can interlock with the lock key (152) and lock channel (142) of the adjacent floor planks.

In some embodiments, interlocking the first and second locking components with the second and first locking components of adjacent planks creates a fluid channel (160). This fluid channel has a first end (162) at the bottom surface and a second end (164) at the top surface of the interlocked planks. The tapered edges of the lock channel and lock key create a V-shaped groove (165) at the first end of the fluid channel. This V-shaped groove (165) is configured to funnel an adhesive (120) into the fluid channel (160). In some embodiments, the fluid channel (160) has a winding path, S-shaped path, or 5-shaped path. When the adhesive (120) flows into the channel path and is cured, the adhesive physically hooks or connects the flooring material to the subfloor to create a monolithic floor.

In some embodiments, the floor plank is composed of vinyl, stone composite flooring material, wood, or tile. For example, the floor plank may be composed of 50-70% crushed limestone. In some embodiments, the floor plank may be plasticizer free. In some embodiments, the floor plank has a back engineered to be more conducive to bond with adhesive.

In some embodiments, the floor plank may have a thickness of about 3-5 mm, for example, 4.5 mm thick. In other embodiments, the floor plank may have a width of about 3-12 inches. In some other embodiments, the floor plank may have a length of about 12-96 inches.

According to some embodiments, the present invention features a flooring system (100) comprising an adhesive (120), and a plurality of floor planks (130). The adhesive may be any of the adhesives described herein. Each plank may be any of the floor planks described herein. In some embodiments, the adhesive (120) is configured to be applied onto a floor surface (110) and the plurality of floor planks (130) are configured to be applied on top of the adhesive and interlock with each other. The V-shaped grooves (165) created by the interlocking floor planks are configured to funnel the adhesive (120) into the fluid channels (160).

In accordance with the embodiments described herein, the adhesive composition may comprise a one-component polyurethane prepolymer. The one-component polyurethane prepolymer may be an aliphatic prepolymer urethane or an aromatic prepolymer urethane. In some other embodiments, the adhesive composition may comprise a silane-modified polycarboxylate or silyl-terminated polyether. In some other embodiments, a polyol can be added to the adhesive composition to increase molecular weight, add thixotropic and modify curative properties.

Polyurethane prepolymers may be formed by combining an excess of diisocyanate with polyol. As depicted in the reaction scheme below, one of the NCO groups of the diisocyanate reacts with one of the OH groups of the polyol, the other end of the polyol reacts with another diisocyanate, and thus the resulting prepolymer has an isocyanate group on both ends. The prepolymer is a diisocyanate itself, and it reacts like a diisocyanate but with several important differences. When compared with the original diisocyanate, the prepolymer has a greater molecular weight, a higher viscosity, a lower isocyanate content by weight (% NCO), and a lower vapor pressure. Instead of a diol, a triol or higher functional polyol could also be used for the polyol in the reaction. Molar ratios of diisocyanate to polyol greater than 2:1 can also be used. These are called quasi-prepolymers.

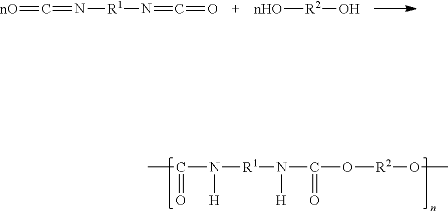

As used herein, a slow-cure urethane prepolymer is a polyisocyanate prepolymer based on diphenylmethane diisocyanate (MDI). High functionality (Fn) and NCO content gives increased reactivity to this component. On its own, this prepolymer will form highly rigid films and must be modified for proper application requirements. As used herein, a flexible binder urethane prepolymer is a polyisocyanate prepolymer based on diphenylmethane diisocyanate (MDI). Lower functionality and NCO content makes this prepolymer less reactive and slower curing. Higher equivalent weight gives this component additional flexibility and gap bridging properties. A single slow-cure urethane prepolymer possessing properties similar to the mixture of the two components could be used. Equivalents or substitutes are within the scope of the present invention.

In one embodiment, a silane is used to react with the urethane prepolymers to form a silane end-capped polymer, i.e. a silane end-capped polyurethane. Non-limiting examples of silanes include alkoxysilanes such as amino-functional alkoxysilanes, gamma-aminopropyltrimethoxysilane, benzylamino, chloropropyl, ureido, vinyl-benzyl-amino, epoxy, epoxy/melamine, the like, or a combination thereof. The alkoxysilane is not limited to the aforementioned examples.

In another embodiment, the flexible binder urethane prepolymer or the slow-cure urethane prepolymer may be substituted or mixed in with a tackifier. Examples of tackifiers include, but are not limited to, polyether polyol, carboxylic diols, and alkoxy-functionalized silicone polymers such as polydimethylsiloxane. For illustrative purposes, the tackifier may be a high molecular weight (e.g., greater than about 4,000 g/mol) polyether polyol. The polyether polyol may help increase coating flexibility. For example, the polyether polyol increases elongation and flexible adhesion yet maintains formulation stability. The polyether polyol may help provide a dry film suitable for use with flooring substrates that demonstrate dimensional properties of expansion and contraction. A softer or more flexible product may also function as a sound abatement system (e.g., for wood flooring installations). A softer or more flexible product may also produce an adhesive bond line that holds carpet tile firmly yet allows removal via peeling the floor back (e.g., at a severe angle) creating cohesive failure of the adhesive.

In some embodiments, the silane end-capped polymeric component comprises a urethane component and a silane component. The silane end-capped polymeric component can form a silanol bridge with the flooring substrate. The silane can be an aminofunctional silane to promote adhesion between inorganic and organic polymers and the like. The silane end-capped polymeric component can range in molecular weight from about 3,000 g/mol to 10,000 g/mol.

In other embodiments, the urethane component facilitates a moisture cure process. In a moisture cure process, water is removed from the coating by reacting with the free isocyanate from the excess urethane prepolymer. The water and isocyanate react to form carbamic acid, which is highly unstable and therefore breaks down into an amine and carbon dioxide. The gaseous carbon dioxide is released from the coating matrix. The amine reacts with other isocyanate molecules and forms a urea linkage, which contributes to an increased crosslink density of the coating.

In some embodiments, the urethane component comprises pure urethane. In other embodiments, the urethane component comprises hybrid polymers of epoxy and urethane. In still other embodiments, the urethane component may be replaced with a polyol of varying molecular weight, ranging from 4,000 g/mol to 10,000 g/mol and having a Hydroxyl number of less than 29.5 mg KOH/g Polyol. As understood by one of ordinary skill, the hydroxyl number is the weight of KOH in milligrams that will neutralize the acid from 1 gram of polyol. In further embodiments, the urethane component may be combined with the polyol of varying molecular weight, but preferably, at least 4,000 g/mol. In some embodiments, the polyol is a polyether polyol or polypropylene glycol. Preferably, a weight ratio of the urethane component to the polyol is about 1:2 to 2:1.

In some embodiments, the desired combination of reactivity and hardness properties of the slow-cure urethane prepolymer and flexible binder urethane prepolymer mixture may be achieved by blending the two components, each with its own specific % NCO content. For example, a slow-cure urethane prepolymer with about 15.8% NCO content can be mixed with a flexible binder urethane prepolymer with about 9.7% NCO content to achieve a desired reactivity and hardness properties that result from the blend. In some embodiments, the % weight of the slow-cure urethane prepolymer is about 10 to 20%, about 20 to 30%, about 30 to 40%, about 40 to 50%, about 50 to 60%, or about 60 to 70%. In other embodiments, the % weight of the flexible binder urethane prepolymer is about 10 to 15%, about 15 to 20%, or about 20 to 30%.

Modifying the ratio between the slow-cure urethane prepolymer and the flexible binder urethane prepolymer may allow for varied application and substrate suitability. For example, in some embodiments, the weight ratio of the flexible binder urethane prepolymer to the slow-cure urethane prepolymer is about 7:10. In some embodiments, the weight ratio of the flexible binder urethane prepolymer to the slow-cure urethane prepolymer is greater than about 7:10, for example about 4:5, 9:10, 1:1, 6:5, 3:2, etc. Such an increase over the 7:10 ratio may increase flexibility and elongation. In some embodiments, high ratios of flexible binder urethane prepolymer to slow-cure urethane prepolymer (e.g., greater than about 7:10) provides a dry film suitable for use with flooring substrates that demonstrate dimensional properties of expansion and contraction. A softer or more flexible product may also function as a sound abatement system (e.g., for wood flooring installations). In some embodiments, the ratio of the flexible binder urethane prepolymer to the slow-cure urethane prepolymer is less than about 7:10, for example about 3:5, 1:2, 2:5, 3:10, 1:5, 1:10, etc. Such a decrease below the 7:10 ratio may reduce flexibility and may increase modulus and/or reduce elastic deformation. In some embodiments, the slow-cure urethane prepolymer can comprise urethane, silane, carboxylate, epoxies, polyesters, phenolics, the like, or a combination thereof. The prepolymers are not limited to the aforementioned examples.

In some embodiments, the slow-cure urethane prepolymer can have an NCO content of about 15 to 19%, or about 17 to 21%, or about 19 to 23%. In other embodiments, the flexible binder urethane prepolymer can have an NCO content of about 2 to 5%, or about 4 to 8%, or about 7 to 10%.

Alternatively, a single urethane prepolymer (a custom prepolymer) (e.g., with a % NCO content similar to the resulting % NCO content of the two-component urethane prepolymer mixture, or with a % NCO content less than or greater than the resulting % NCO content of the two-component urethane prepolymer mixture) could be used to achieve a desired reactivity and hardness properties. For example, a urethane prepolymer with a % NCO content of about 12% NCO could have workable reactivity and hardness properties, thereby eliminating the need to blend two separate components. The percent weight of the urethane prepolymer can be about 10 to 20%, about 20 to 30%, about 30 to 40%, about 40 to 50%, about 50 to 60%, about 60 to 70%, or about 70 to 85%. In other embodiments, the urethane prepolymer can have an NCO content of about 7 to 10%, or about 10 to 15%, or about 15 to 18%, or about 18 to 23%.

Altering the ratio to incorporate more of higher functionality urethane creates hard setting adhesives suitable for applications including masonry, concrete anchoring, and concrete laminates. Due to the hydrophobic silanol-bridge bonding mechanism, the adhesive composition exhibits excellent exterior stability to changes in humidity and temperature. Harder setting variants of the formulation provide maximum bond strengths to flexible substrates.

In some embodiments, the urethane prepolymer may be substituted with a polycarboxylate (e.g., to create a silane end-capped polycarboxylate). In some embodiments, silane-modified polyether or polyester materials may be incorporated into the adhesive composition of the present invention as coupling agents to reduce polyisocyanate content. In other embodiments, the silane-modified polyether or polyester materials may replace the urethane component. They can be used in combination with silane terminated urethane polymers or as functional substitutes.

Without wishing to be bound to a particular theory or mechanism, the silane-modified polyether or polyester materials can modify the mechanical properties of the adhesive, produce clear formulations, and promote adhesion. These materials may be silane terminated. The material may have a density averaging about 1.11 to 1.15 g/ml, and a viscosity in the range of about 1800 to 2000 mPa-s.

In non-limiting embodiments, the silane-modified polyether or polyester may be GENIOSIL® Silane-Modified polymer products (https://www.wacker.com/cms/en-us/products/product-groups/silane-modified-polymers/silane-modified-polymers.html).

Hydrophobic modification is the treatment of a substrate's surface so that it becomes non-polar. A surface can be polar because of the hydrogen bonding locations. By eliminating or reducing the hydrogen bonding at the surface, the surface is shielded from interacting with water molecules and is therefore rendered hydrophobic. For calcium carbonate, it is theorized that although calcium carbonates do not form stable bonds with silicates, the low molecular weight and low surface energy of the silicates allow for the silicates to penetrate porous structures and encapsulate the substrate in a silica-rich network.

In some embodiments, the hydrophobically modified reinforcing extender may contribute to the overall waterproof quality of the cured, waterproof polymeric matrix coating. In other embodiments, the hydrophobically modified reinforcing extender provides an increase in mechanical strength, provides dimensional stability, builds viscosity, reduces shrinkage, and reduces cracking in the coating. For example, a reinforcing extender, such as a mineral component can be hydrophobically modified by adding a silane or aliphatic silane. Examples of mineral components include, but are not limited to, calcium carbonate, limestone, layered clays, aluminates, hydrotalcite and the like. Illustrative of a hydrophobically modified reinforcing extender is a hydrophobically modified calcium carbonate.

A thixotropic agent can function as a thickener and/or to build viscosity. Preferably, the thixotropic agent is hydrophobically modified. In some embodiments, the following may be used as thixotropic agents: fumed silica, hydrogenated castor oil derivatives, hydrophobically modified cellulosic materials, surface modifiers based on polyethylene, polypropylene and PTFE technologies, hydrated magnesium aluminosilicate and the like.

In some embodiments, an aliphatic quenching agent can terminate chemical reactions such that the coating formulation has minimal to no reactivity (i.e. inert). A non-limiting example of the aliphatic quenching agent is an aliphatic fatty acid ester mixture. The aliphatic fatty acid ester mixture is a UV stable, zero VOC solvent having low viscosity, possessing high flash point and low volatility. This solvent readily biodegrades in the environment (>90% in 28 days). This solvent is not derived from petroleum distillates, is non-toxic, non-hazardous under RCRA, non-HAPS and meets clean air solvent certification. Aliphatic Fatty Acid Ester Mixture is sold under various trade names, for example: Solvation (Shepard Bros, La Habra, CA) and Promethean ME (Promethean Biofuels, Temecula, CA). In some embodiments, the following agents may be used as aliphatic fatty acid esters: fatty acid methyl esters (FAME) such as myristic acid, palmitic acid, palmitoleic acid, stearic acid, oleic acid, linoleic acid, eicosanoic acid, docosenoic acid and the like, which are molecules in biodiesel derived from the transesterification of vegetable oils and the like.

Further non-exhaustive examples of quenching agents include mixtures of aliphatic hydrocarbons of various molecular weights and fractionation containing alkanes, alkenes and alkynes derived, but not exclusively, from petroleum sources. Mixtures may also contain natural hydrocarbons from biological sources such as terpenes and isoprene and the like. These mixtures exhibit partial solubility of the urethane formulation components. The following tables are non-limiting examples of properties of quenching agents. Equivalents or substitutes are within the scope of the present invention.

In other embodiments, a catalyst is used to accelerate chemical reactions and promote curing of the coating. The catalyst is preferably an aliphatic metal catalyst such as dibutyltindilaurate. The percent weight of the aliphatic metal catalyst is about 0.001 to 5% (e.g., 0.1%). Other examples of the aliphatic metal catalyst include, but are not limited to, organometallic compounds based on mercury, lead, tin, bismuth, zinc, the like, or a combination thereof.

In further embodiments, a moisture scavenger may be used to limit the amount of moisture contamination absorbed from the atmosphere. In one embodiment, the moisture scavenger comprises vinyl-functionalized methoxy silane, such as vinyltrimethoxysilane.

In yet other embodiments, adhesion promoters may be used as cross-linking agents to improve adhesion between inorganic fillers, basic materials and resins. Examples of adhesion promoters include, but are not limited to, silane based crosslinkers such as oximesilane crosslinkers, alkyl-functionalized silane crosslinkers, aminosilane crosslinkers, and alkoxysilane crosslinkers such as glycidoxypropyltrimethoxysilane. For example, glycidoxypropyltrimethoxysilane is an epoxy substituted alkoxysilane used as a cross-linking agent and adhesion promoter.

Embodiments of the adhesion promoters include, but are not limited to, dimorpholinediethylamine, dimorpholinodiethylether, methylmorpholine, ethylmorpholine, 4-butylmorpholine, 4-(2-methoxyethyl) morpholine, 4-[2-(dimethylamino)ethyl]-morpholine, 4-[2-(dimethylamino)ethyl]morpholine, 4-(2-aminopropyl) morpholine, or N,N-dibenzylidenpolyoxypropylenediamine.

As another example, the crosslinkers may be oxime-silane based crosslinkers such as methylethylketoximino (MEKO) silanes. Non-limiting examples of MEKO silanes include methyl tris (MEKO) silane, phenyl tris (MEKO) silane, vinyl tris (MEKO) silane, tetrakis (MEKO) silane, and dimethyl bis (MEKO) silane. Equivalents or substitutes are within the scope of the present invention.

Oxime silane-based crosslinkers allow for neutral moisture-cure. Using these silane compounds, 2-butanone oxime or MEKO is released, but no acetic acid or amine is released unlike in acid or alkaline crosslinking systems. Without wishing to limit the invention to a particular theory or mechanism, it is believed that MEKO functions by binding drying agents and metal salts that catalyze the oxidative crosslinking of the coating mixture. Once the coating mixture has an hour or so to dwell on the concrete.

In still other embodiments, additional tackifiers may be used to plasticize the coating and/or reduce moisture sensitivity and/or enhance flexibility and adhesion to low energy flooring substrate. In some embodiments, the tackifier is the methyl ester of rosin. Equivalents or substitutes are within the scope of the present invention.

### Example

The following is a non-limiting example of the present invention. It is to be understood that said example is not intended to limit the present invention in any way. Equivalents or substitutes are within the scope of the present invention.

In some embodiments, the floor plank of the present invention has the key performance features:
i) 4.5 mm/20 mil, 70% stone polymer core, plasticizer-free
ii) Interlocking design, waterproof to 100% RH
iii) Waterproof to standing water
iv) Slip resist wet 0.76
v) Meets CHPS (01350), contributes LEED
vi) Static load to 2000 psi
vii) Warranted over non-porous substrates
viii) Provides an IIC 78 (Amplio+Aquaflex)
ix) No moisture testing, no vapor barrier, and no active HVAC required

As used herein, the term “about” refers to plus or minus 10% of the referenced number.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

Reference numbers recited herein, in the drawings, and in the claims are solely for ease of examination of this patent application and are exemplary. The reference numbers are not intended in any way to limit the scope of the claims to the particular features having the corresponding reference numbers in the drawings.

What is claimed is:

1. A flooring plank (130) comprising:
a) a first locking component (140) disposed on a bottom surface (132) along one side (134) of the plank, wherein the first locking component comprises a tongue (141) adjacent to a lock channel (142), wherein the lock channel (142) has a tapered edge (143) from the bottom surface (132), and
b) a second locking component (150) disposed on a top surface (136) along an opposing side (138) of the plank, wherein the second locking component comprises a lock key (152) adjacent to a groove (151), wherein the lock key (152) has a tapered edge (153) from the bottom surface;
wherein the tongue (141) and groove (151) have complementary shapes such that they can interlock with the groove (151) and tongue (141) of adjacent floor planks,
wherein the lock channel (142) and lock key (152) have complementary shapes such that they can interlock with the lock key (152) and lock channel (142) of the adjacent floor planks,
wherein interlocking of the first and second locking components with the second and first locking components of adjacent planks creates a fluid channel (160) having a first end (162) at the bottom surface and a second end (164) at the top surface, wherein the tapered edges of the lock channel and lock key create a V-shaped groove (165) at the first end of the fluid channel, wherein the V-shaped groove (165) is configured to funnel an adhesive (120) into the fluid channel (160).

2. A flooring system (100) comprising:
a) a flooring adhesive (120); and
b) a plurality of flooring planks (130), wherein each flooring plank (130) comprises:
i) a first locking component (140) disposed on a bottom surface (132) along one side (134) of the plank, wherein the first locking component comprises a tongue (141) adjacent to a lock channel (142), wherein the lock channel (142) has a tapered edge (143) from the bottom surface (132); and
ii) a second locking component (150) disposed on a top surface (136) along an opposing side (138) of the plank, wherein the second locking component comprises a lock key (152) adjacent to a groove (151), wherein the lock key (152) has a tapered edge (153) from the bottom surface;
wherein the tongue (141) and groove (151) have complementary shapes such that they can interlock with the groove (151) and tongue (141) of the other flooring planks,
wherein the lock channel (142) and lock key (152) have complementary shapes such that they can interlock with the lock key (152) and lock channel (142) of the adjacent floor planks,
wherein interlocking of the first and second locking components with the second and first locking components of adjacent planks creates a fluid channel (160) having a first end (162) at the bottom surface and a second end (164) at the top surface, wherein the tapered edges of the lock channel and lock key create a V-shaped groove (165) at the first end (162) of the fluid channel, wherein the V-shaped groove (165) is configured to funnel the flooring adhesive (120) into the fluid channel (160).

3. The flooring system (100) of claim 2, wherein the flooring adhesive (120) is configured to be applied onto a floor surface (110), wherein the plurality of floor planks (130) are configured to be applied on top of the flooring adhesive and interlock with each other, wherein the V-shaped grooves (165) created by the interlocking floor planks is configured to funnel the flooring adhesive (120) into the fluid channels (160).

4. The flooring system (100) of claim 2, wherein the flooring adhesive (120) and the interlocking floor planks (130) create a monolithic flooring structure with the floor surface.

5. The flooring system (100) of claim 2, wherein the flooring adhesive (120) comprises
a) a silane modified polymer;
b) a reinforcing extender;
c) one or more thixotropic agents; and
d) an adhesion promoter;
wherein the cured adhesive is waterproof, hydrolytically stable, and pH-resistant.

6. The flooring system (100) of claim 5, wherein the silane modified polymer comprises a silane modified polyurethane, a silane modified polyether, a silane modified polyol, a silane modified polyester, a silane polycarboxylate, or a combination thereof.

7. The flooring system (100) of claim 6, wherein an NCO content of the silane modified polyurethane is about 0.001% to about 30%.

8. The flooring system (100) of claim 6, wherein the silane end-capped urethane comprises a flexible binder urethane, a slow-cure urethane, or both.

9. The flooring system (100) of claim 6, wherein the silane modified polyurethane is an aliphatic urethane, an aromatic urethane, or a combination thereof.

10. The flooring system (100) of claim 5, wherein the reinforcing extender is hydrophobically modified.

11. The flooring system (100) of claim 5, wherein the one or more thixotropic agents are hydrophobically modified.

12. The flooring system (100) of claim 5, wherein the adhesion promoter enables bonding of the cured adhesive to a non-porous substrate.

13. The flooring system (100) of claim 5, wherein the adhesion promoter is dimorpholinediethylamine, dimorpholinodiethylether, methylmorpholine, ethylmorpholine, 4-butylmorpholine, 4-[2-(dimethylamino)ethyl]morpholine, 4-(2-methoxyethyl) morpholine, 4-[2-(dimethylamino)ethyl]morpholine, 4-(2-aminopropyl) morpholine, or N,N-dibenzylidenpolyoxypropylenediamine.

14. The flooring system (100) of claim 5, further comprising an anti-skinning agent.

15. The flooring system (100) of claim 14, wherein the anti-skinning agent is a methylethylketoximino (MEKO) silane according to the formula: 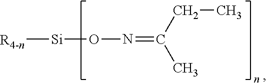
wherein n ranges from 1 to 4, wherein R is an alkyl, an alkene, or aryl group.

16. The flooring system (100) of claim 5, further comprising a quenching agent, a tackifier, one or more moisture scavengers, a magnetic agent, a pigment, or a combination thereof.

17. The flooring system (100) of claim 2, wherein when applied to the floor surface (110), the flooring adhesive (120) maintains stickiness for about 3-4 hours before hardening.

18. The flooring system (100) of claim 2, wherein the floor surface (110) is polished concrete or concrete with epoxy sealer.

19. The flooring system (100) of claim 2, wherein the floor surface (110) is an epoxy and glass surface.

20. The flooring system (100) of claim 2, wherein the adhesive composition is configured to adhere to the floor surface (110) without further modification of the floor surface (110).
